(19) United States
(12) Patent Application Publication
(10) Pub. No.: US 2024/0263486 A1
(43) Pub. Date: Aug. 8, 2024

(54) UNIVERSAL DOOR LOCK INDICATING DEVICES, KITS, AND METHODS

(71) Applicants: Zachary Dan Griffith, Herriman, UT (US); Rachelle Lynn Griffith, Herriman, UT (US)

(72) Inventors: Zachary Dan Griffith, Herriman, UT (US); Rachelle Lynn Griffith, Herriman, UT (US)

(21) Appl. No.: 18/641,252

(22) Filed: Apr. 19, 2024

Related U.S. Application Data
(63) Continuation-in-part of application No. 17/979,585, filed on Nov. 2, 2022.

(51) Int. Cl. E05B 17/22; E05B 47/00

(52) U.S. Cl. CPC E05B 17/22; E05B 2047/0058; E05B 2047/0069; E05B 2047/0091

(57) ABSTRACT

Universal door lock indicating devices, kits, and methods are described. The kits and devices can include a flexible or rigid material designed to fit over a deadbolt lock turnpiece, or a compartment design to fit adjacent to deadbolt hardware, a sensor designed to detect whether the deadbolt lock turnpiece is in a locked or unlocked position such as a horizontal or vertical position, and a wireless transmitter which can be operatively connected to receive output from the sensor. The methods can include receiving a wireless transmission from a device of the disclosure, and outputting the locked or unlocked status of a deadbolt based upon information in the wireless transmission.

### CROSS-REFERENCE TO RELATED APPLICATIONS

The present application is a Continuation-in-Part (CIP) application of U.S. patent application Ser. No. 17/979,585, filed on Nov. 2, 2022, the disclosure of which is hereby incorporated by reference in its entirety.

### FIELD

The present disclosure is directed to the field of home security. More particularly, the present disclosure relates to devices, kits, systems, and methods that inform a user of the locked or unlocked status of a deadbolt.

### BACKGROUND

Doors are often left unlocked by other family members such as children. Countless nights, vacations, and outings are disrupted by that eerie feeling that a door may not be locked. Home alarm systems can indicate that doors are closed, but cannot provide information that a deadbolt is actually locked. Electronic door locks can be accessed remotely to physically lock and unlock a deadbolt, but these are expensive and difficult to install.

### SUMMARY

In general, in a first aspect, the disclosure features a device. The device can include a flexible material designed to fit over a deadbolt lock turnpiece, a sensor designed to detect whether the deadbolt lock turnpiece is in a locked or unlocked position such as a horizontal or vertical position, and a wireless transmitter operatively connected to receive output from the sensor.

In general, in a second aspect, the disclosure features a device. The device can include rigid material designed to fit over a deadbolt lock turnpiece or a portion thereof, a sensor designed to detect whether the deadbolt lock turnpiece is in a locked or unlocked position such as a horizontal or vertical position, and a wireless transmitter operatively connected to receive output from the sensor.

In general, in a third aspect, the disclosure features a device. The device can include a module designed to replace a deadbolt lock turnpiece and integrate with deadbolt hardware, a sensor designed to detect whether the deadbolt lock is in a locked or unlocked position such as a horizontal or vertical position, and a wireless transmitter operatively connected to receive output from the sensor. The module can have a compartment designed to fit a battery, a PCB, and the wireless transmitter. The module can integrate with deadbolt hardware by way of plug inserts that join the module with the deadbolt hardware.

In general, in a fourth aspect, the disclosure features a device. The device can include a compartment designed to be attached to a door and disposed outside a deadbolt base, a sensor disposed within the compartment and designed to detect whether a deadbolt lock turnpiece installed on the deadbolt base is in a locked or unlocked position such as a horizontal or vertical position, and a wireless transmitter disposed within the compartment and operatively connected to receive output from the sensor.

In general, in a fifth aspect, the disclosure features a kit. The kit can include flexible or rigid material designed to fit over a deadbolt lock turnpiece, a sensor designed to detect whether the deadbolt lock turnpiece is in a locked or unlocked position such as a horizontal or vertical position, and a wireless transmitter.

In general, in a sixth aspect, the disclosure features a method. The method can include receiving a wireless transmission from a device of the disclosure, and outputting the locked or unlocked status of a deadbolt based upon information in the wireless transmission.

In general, in a seventh aspect, the disclosure features a method. The method can include fitting a device of the disclosure over or adjacent to a deadbolt lock turnpiece, turning the deadbolt lock turnpiece to lock or unlock a deadbolt operably linked to the deadbolt lock turnpiece, and generating a wireless transmission from the wireless transmitter.

Features of the devices, kits, and methods can include the following:

The flexible material can have an oblong dimension and an opening capable of being stretched to accommodate a shape of the deadbolt lock turnpiece. The flexible material can form at least one core designed to fit over an end of the deadbolt lock turnpiece or can form two opposed cores designed to fit over either end of the deadbolt lock turnpiece with a stretchable component therebetween. The device can include a rigid end designed to fit over one end of the deadbolt lock turnpiece and an opposing flexible end including the flexible material and designed to fit over an opposing end of the deadbolt turnpiece. The device can include a center cavity capable of stretching around a deadbolt lock turnpiece. The device can further include a pair of flexible zones flanking the center cavity each having a smaller cavity.

The rigid material can include a pair of complementary rigid pieces designed to snap together. The pair of complementary rigid pieces can be designed to cover opposing ends of the deadbolt lock turnpiece and snap together therebetween. The pair of complementary rigid pieces can be designed to snap together by way of ratchet grooves one a first piece and side cups on a second piece. The pair of complementary rigid pieces can be designed to snap together along a frontal plane transversing a length of the device. The pair of complementary rigid pieces can include a main body and an access panel designed to cover a chamber in the main body. The pair of complementary rigid pieces can include a first rigid piece comprising lock tabs and a second rigid piece comprising a recess designed to receive the lock tabs. At least one piece can have a notch designed to be installed over deadbolt hardware.

The compartment disposed outside a deadbolt base can be designed to be positioned adjacent to a portion of the deadbolt base or can be designed to surround the deadbolt base. The compartment can include an adhesive on one surface capable of attachment to the door.

The device can be dimensioned to hold one or more battery including 9 volt battery, an AAA battery, or a coin battery. The sensor can be disposed on a deadbolt base or on or underneath the flexible or rigid material. The device can further include a LED. The sensor and transmitter can be disposed on a printed circuit board, and the printed circuit board can be disposed on or within the flexible or rigid material. The sensor and transmitted can also not be disposed on a printed circuit board such that the sensor and wireless transmitter are disposed directly on or within the flexible or rigid material. The device can be battery powered. The device or kit can further include a magnet. The sensor can be a magnetometer designed to detect the magnet. The magnet can be disposed or placed on a deadbolt lock base or a deadbolt turnpiece. The magnet can be disposed or placed to align with a longitudinal axis of the deadbolt turnpiece when the deadbolt turnpiece is in a horizontal position, or align with a longitudinal axis of the deadbolt turnpiece when the deadbolt turnpiece is in a vertical position. The device or kit can include a printed circuit board, where the sensor and wireless transmitter are disposed on the printed circuit board. The sensor can be a bubble sensor. The wireless transmitter can be a BLUETOOTH® transmitter. The flexible material can include silicone, polyvinyl chloride, polyurethane, latex, synthetic rubber, natural rubber, or nitrile, or a combination thereof. The rigid material can include polycarbonate. The locked or unlocked status of the deadbolt can be outputted on a graphical user interface in text form or in symbol form, and alternatively or in addition, outputted in audio form. The time and date of the transmission from the transmitter can be outputted. A name or an identity of a door associated with a device of the disclosure can be inputted.

It should be understood that the devices, kits, and methods are not to be considered limitations on the invention defined by the claims. The featured devices, kits, and methods can be implemented in one or more ways using one or more features depicted in the drawings, described in the detailed description, and set forth in the claims. The featured devices, kits, and methods can be combined in one or more ways when implemented.

### BRIEF DESCRIPTION OF THE DRAWINGS

The accompanying drawings illustrate certain aspects and principles of the implementations set forth, and should not be construed as limiting.

FIGS. 1A-1E are diagrams showing various perspective views of a deadbolt turnpiece having a deadbolt turnpiece cover installed thereupon according to one implementation. FIGS. 1A and 1B are diagrams showing a top view of a deadbolt lock with deadbolt turnpiece cover installed thereupon as it would be perceived on a door from someone inside the door according to one implementation, with FIG. 1A showing the deadbolt turnpiece in a vertical unlocked position and FIG. 1B showing the deadbolt turnpiece in a horizontal locked position. FIGS. 1C and 1D are diagrams showing a front view (FIG. 1C) and a back view (FIG. 1D) of the deadbolt turnpiece in isolation with the deadbolt turnpiece cover installed. FIG. 1E is a diagram showing a side view of the deadbolt turnpiece with the deadbolt turnpiece cover installed.

FIG. 2 is a circuit diagram showing a configuration of a battery, printed circuit board (PCB), sensor, and transmitter according to one implementation.

FIG. 3 is a graphical user interface according to one implementation.

FIGS. 4 and 5 are flow charts depicting method steps according to implementations.

FIGS. 6A-6C are diagrams showing a stretch-over deadbolt turnpiece cover according to one implementation, with FIG. 6A showing a perspective view of the deadbolt turnpiece cover installed on a deadbolt turnpiece, FIG. 6B showing a perspective view of the deadbolt turnpiece cover uninstalled, and FIG. 6C showing a lateral cross-section of the deadbolt turnpiece cover.

FIGS. 7A-7C are diagrams showing a snap-over deadbolt turnpiece cover according to one implementation, where FIG. 7A shows the deadbolt turnpiece cover installed on a deadbolt turnpiece, FIG. 7B shows a perspective view of the individual complementary parts of the deadbolt turnpiece cover, and FIG. 7C showing a perspective view of one part of the deadbolt turnpiece cover with interior components.

FIGS. 8A-8C are diagrams showing a device surrounding the entire deadbolt plate, with FIG. 8A showing a perspective view and FIGS. 8B and 8C showing a front view.

FIGS. 9A-9C are diagrams showing a stretch-over deadbolt turnpiece cover according to one implementation, with FIG. 9A showing a perspective view of the deadbolt turnpiece cover installed on the deadbolt turnpiece, FIG. 9B showing a perspective view of the deadbolt turnpiece cover uninstalled, and FIG. 9C showing a side view of the deadbolt turnpiece cover uninstalled.

FIGS. 10A and 10B are diagrams showing a snap-together deadbolt turnpiece cover according to one implementation, where FIG. 10A shows a perspective view of the individual components uninstalled, and FIG. 10B shows a perspective view of the deadbolt turnpiece cover installed on the deadbolt turnpiece.

FIG. 11 is a diagram showing a perspective view of a side component installed adjacent to the deadbolt turnpiece according to one implementation.

FIGS. 12A-12C are diagrams showing an endcap deadbolt turnpiece cover, according to one implementation where FIG. 12A shows a perspective view of the cover installed on the turnpiece, FIG. 12B shows a perspective view of the turnpiece cover uninstalled, and FIG. 12C shows a lateral cross-sectional view of the deadbolt turnpiece cover.

FIGS. 13A-13D are diagrams showing a 3-zone collapsing deadbolt turnpiece cover according to one implementation, where FIGS. 13A and 13D show perspective views and FIG. 13B shows a top view while FIG. 13C shows a cross-sectional view.

FIGS. 14A-14C are diagrams showing a deadbolt turnpiece replacement according to one implementation, where FIGS. 14A and 14B show perspective views, and FIG. 14C shows a top view.

FIG. 14D is a diagram showing various plug inserts for integration of the turnpiece replacement of FIGS. 14A-14C onto the deadbolt hardware.

### DETAILED DESCRIPTION

Reference will now be made in detail to various illustrative implementations. It is to be understood that the following discussion of the implementations is not intended to be limiting.

In one aspect, the disclosure provides a universal door lock signaler device usable with common deadbolt mechanisms. The door lock signaler can be implemented as a deadbolt turnpiece (also known as a thumbturn) sheath or cover that detects whether a door lock turnpiece is in a locked state or an unlocked state. The deadbolt turnpiece cover can be implemented as a flexible sheath that stretches and slips over the deadbolt turnpiece or a rigid plastic cover having complementary portions that fit together to fit over a standard turnpiece for a deadbolt or other lock on most exterior residential doors. The rigid plastic implementations can be made to adjust size in all three directions, such as through the use of crush ribs or filler pads or parts to create tight fitment with the turnpiece handle. The flexible sheath or rigid plastic cover can include a position sensing mechanism to sense when the lock is in a locked or unlocked position. Such sensing mechanism can include components to complete a circuit such as cooperating magnets located in the sheath or cover and at the locked or unlocked position on the lock base. The universal deadbolt turnpiece cover works and can be retrofitted with existing, standard bolt hardware. The flexible sheath or hard plastic cover can also include a wireless signal transmitter to send a signal when the turnpiece is either in the locked or unlocked position. The sheath or cover can also include a battery to power the transmitter and/or the sensing mechanism as well as a printed circuit board (PCB) that holds electronic components such as the wireless transmitter. Another implementation provides entire replacement of the deadbolt turnpiece with a compartment which hosts the battery, wireless transmitter, PCB, and other electronic components and integrates with existing deadbolt hardware by way of adapter components. Additional implementations provide a compartment that hosts the battery, wireless transmitter, a sensor, PCB, and other electronic components situated outside but adjacent to conventional deadbolt mechanisms that senses the orientation of the deadbolt turnpiece such as by way of a magnetic component placed on the deadbolt turnpiece. Also provided is an application executable on a computer or computing device, such as a mobile phone, that displays the locked or unlocked status of one or more doors where the device is installed, based on the wireless communication received from the universal deadbolt turnpiece cover.

Advantages of the deadbolt turnpiece detection device, only some of which are described herein, include relative simplicity in number of components, reduced cost compared to automatic door locking mechanisms, and universality as a result of the flexible or hard plastic material. As the cover retrofits seamlessly to existing manual deadbolt hardware, no tools, drilling, or low-voltage experience are required for installation. While comparable market security products are alarm-based with much more permanent installation requirements, implementations of the universal turnpiece cover simply fit like a latex glove or plastic cover over the fixture or adjacent to the fixture and provide basic peace of mind.

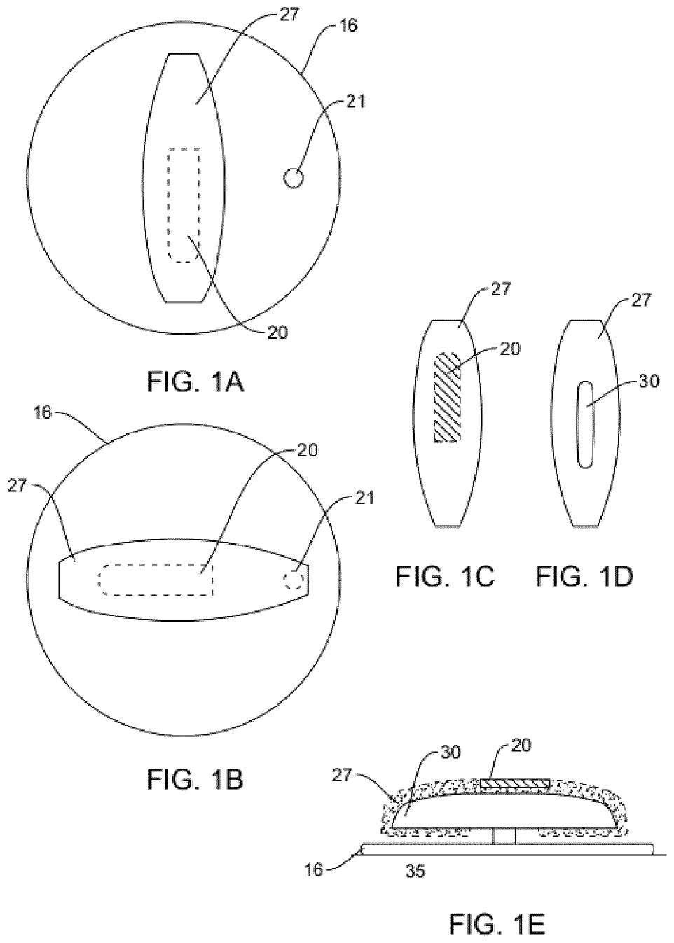

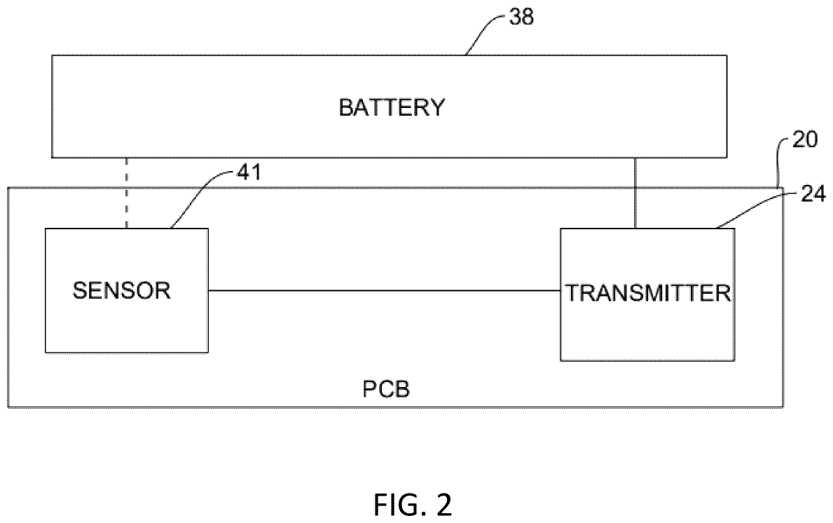

One implementation of a deadbolt turnpiece cover is shown in FIGS. 1A-1E. A deadbolt turnpiece 30 is connected to a deadbolt base 16 installed on a door surface 35, as shown in FIG. 1E. As shown in FIGS. 1A-1E, the deadbolt turnpiece 30 is covered with a flexible cover 27. The flexible cover 27 can be made of an elastic material which can include one or more flexible polymers or elastomers, such as silicone, polyvinyl chloride, polyurethane, latex, synthetic rubber (Neoprene), natural rubber, or nitrile. The flexible cover 27 can have an oblong curvilinear (e.g., oval) or rectangular shape dimensioned to be slightly smaller than the length and width of conventional door deadbolt turnpieces. The flexible cover can be dimensioned to have an opening which can be fitted over a deadbolt turnpiece such that the cover can stretch and expand and cover the door turnpiece while leaving a minor portion (representing the opening) in the back of the turnpiece uncovered, as shown in FIG. 1D. Exemplary dimensions include a range of 1 inch to 2 inches long, including 1.1, 1.2, 1.3, 1.4, 1.5, 1.6, 1.7, 1.8, 1.9 inches long, 0.20 to 0.80 inches wide, including 0.25, 0.30, 0.35, 0.40, 0.45, 0.50, 0.55, 0.60, 0.65, 0.70, 0.75 inches wide, and 0.1 to 0.5 inches deep, including 0.2, 0.3, 0.4 inches deep. The flexible cover can be dimensioned to cover any shape of deadbolt turnpiece, including circular, oval, square, rectangular, or polygonal shape, or a combination of these. The flexible cover can be glove-like as described above to provide a tight fit through the elastic material, or can be implemented in other ways using other materials such as fabric, such as an adjustable sleeve that can be wrapped around the deadbolt turnpiece and tightened to fit the width of the turnpiece, much like a cuff. The flexible cover can include a PCB 20 disposed within or on either the front or back surface of the flexible cover. The PCB can have a position sensor installed which senses whether the turnpiece is in a locked or unlocked position. The position sensor can be a bubble sensor, a magnetic sensor (e.g., magnetometer), or other type of position sensor that determines whether the orientation of the deadbolt turnpiece is in a vertical unlocked position or a horizontal locked position. The magnetic sensor can detect a magnet 21 positioned on the deadbolt base 16 such that the position sensor moves in proximity to the magnet 21 when the deadbolt turnpiece is in a horizontal locked position (as shown in FIG. 1B) or vertical unlocked position (as shown in FIG. 1A). The magnet can be attached to the deadbolt base through magnetism or through adhesive means, such as double-sided adhesive tape, hook and loop fasteners with adhesive backing, or glue. Other types of position sensors that can be implemented in the device include potentiometric position sensors (resistance-based), inductive position sensors, eddy current-based position sensors, capacitive position sensors, magnetostrictive position sensors, hall effect-based magnetic position sensors, fiber-optic position sensors, optical position sensors, and ultrasonic position sensors. The PCB 20 can also include a wireless transmitter (BLUETOOTH®, WIFI) in communication with the position sensor for wirelessly communicating output from the position sensor. The flexible cover can also include a battery (not shown in FIGS. 1A-1E) for powering the transmitter and/or the sensor. The battery can be a lithium-ion battery of appropriate voltage and size, such as a 3-volt lithium coin battery. The sensor, transmitter, and/or battery can be imbedded within the flexible cover, or can be attached to either the front or the back of the flexible cover, either freely or on the PCB. The battery can also be mounted separately from the flexible cover, such as on the deadbolt base 16, using a separate mount, and attached to the PCB with electrical leads. These components are dimensioned to be sufficiently thin to be incorporated in any of these configurations. FIG. 2 shows a circuit diagram showing the operative electrical connections between the transmitter 24, battery 38, and position sensor 41. The transmitter 24 and position sensor 41 are disposed and connected together on the PCB 20; the battery 38 powers the transmitter 24 and optionally the sensor 41 (depending upon what type of sensor) through electrical contacts on the PCB 20. It should be noted that the configuration shown in FIG. 2 is just an illustrative example; the relative positions of the transmitter 24, battery 38, and position sensor 41 can differ when implemented within the flexible cover while providing the same electrical connectivity. Other implementations may not include the PCB such that the components are only connected by electrical contacts or leads such as wires. The sensor 41 sends a signal to the wireless transmitter 24 with respect to detected orientation of the deadbolt turnpiece. The wireless transmitter 24 transmits data to a computer or computing device indicating the orientation of the deadbolt turnpiece. The computer or computing device has an application installed that can decode the data transmission communicated by the wireless sensor and display the information the data conveys as to whether a door of the installed device has a locked or unlocked deadbolt.

Another implementation provides a device or a kit which includes a piece of flexible or rigid plastic material designed to fit over or adjacent to a deadbolt lock turnpiece, a sensor designed to detect whether the deadbolt lock turnpiece is in a horizontal or vertical position, and a wireless transmitter. The device or kit can include a magnet that can be applied to a deadbolt base such as through magnetic attraction in the case of a metallic deadbolt base or to the deadbolt turnpiece itself. The device or kit can also include adhesive means for attaching the magnet, such as double-sided adhesive tape, hook and loop strips with adhesive backing, or glue. The device or kit can lack the flexible or hard plastic material in some implementations, such that the sensor and wireless transmitter are installed through other means, such as adhesive means, either as separate components or on a PCB. The device or kit can include a battery in some implementations.

Another implementation provides a system including a set of manual deadbolt hardware which includes a device or kit of the disclosure or one or more components thereof. The system can include a deadbolt turnpiece and a sensor and transmitter capable of being installed on or within the deadbolt turnpiece. The sensor and transmitter can be installed on a printed circuit board that can then be installed on or within the deadbolt turnpiece. The sensor and transmitter, or PCB including them, can be installed on the deadbolt turnpiece by way of the flexible or rigid cover, or through other suitable attachment apparatus, such as an adjustable sleeve that can be wrapped around the deadbolt turnpiece and tightened to fit the width of the sleeve, much like a cuff. In some implementations, the sensor and transmitter, or PCB including them, are preinstalled on or within the deadbolt turnpiece such that no flexible or rigid material or other attachment apparatus is present or required.

The following figure depicts an implementation of a graphical user interface of a downloadable application and/or a dedicated website capable of performing method implementations or portions thereof described herein. The graphical user interface will be described with respect to specific icons, fields, buttons, and other features which are displayed on a screen or display of a computer or computing device such as a mobile phone and are selectable by a user of the application and/or website by way of a touchscreen, trackpad, mouse, keyboard, or other input device such as a pen or stylus and provide for input. Selection of the icons and other features by a user activates certain method steps for performing various functions executable as computer program instructions on a stationary computer or portable computer/computing device. These computer program instructions may be provided to one or more processor(s) of a general-purpose computer, special purpose computer, or other programmable data processing device or combination of devices, such that the instructions, which execute via the processor or processors of the computer or other programmable data processing device(s), create means for implementing the method steps or portions thereof. As such, methods described herein or portions thereof can be performed as a series of steps which are implemented as computer-readable code, computer-readable instructions, computer-executable instructions, “application(s)”, or “software” performed by one or more processor(s). Such software can be loaded onto a memory or memories of a computer, portable computer/computing device, or system or combination thereof, as an application or program (or multiple applications and/or programs) capable of performing one or more steps of the method implementations. As can be appreciated, different steps or groups of steps of the method implementations can be performed by different computers or computing devices, or some or all can be performed by a single computer or computing device.

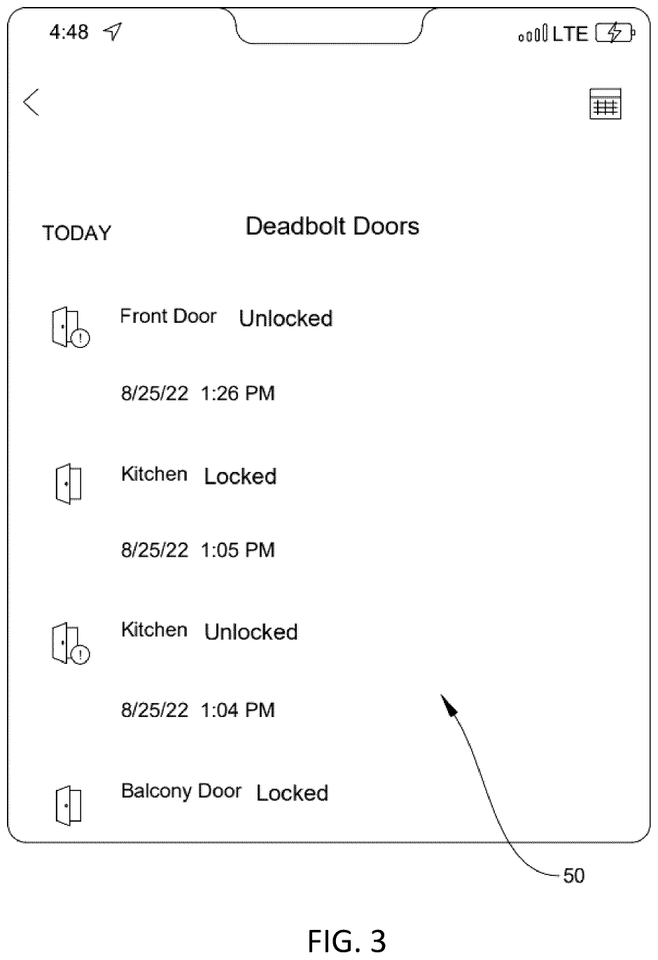

FIG. 3 shows a graphical user interface 50 of an application for a computer or computing device according to one implementation. The graphical user interface displays the name of each door on which the deadbolt turnpiece cover is installed, such as Front Door, Kitchen, etc., based on signals received from the transmitter from each deadbolt turnpiece cover device. The application can have functionality that allows the user to assign the name of the door that each deadbolt turnpiece cover is installed, based on the received wireless signal. The graphical user interface displays whether the received wireless signal indicates that the door deadbolt is locked or unlocked, in text format or as a graphical symbol. The graphical user interface also displays the time and date of the last transmission received from the wireless transmitter. The application can optionally include other functions such as an audible alarm that is played from a speaker of the computer or computing device when a deadbolt is left unlocked. The audible alarm can be customized to broadcast a different sound for each door. The audible alarm can also be implemented as a voice that conveys that a door deadbolt is left unlocked. The application outputs visual or auditory information to indicate the locked or unlocked status of the door deadbolt, and allows customization as to the form of the output, whether it be a graphical symbol, text, or audio. The application also allows naming of each deadbolt turnpiece cover device based on the door that it is installed on.

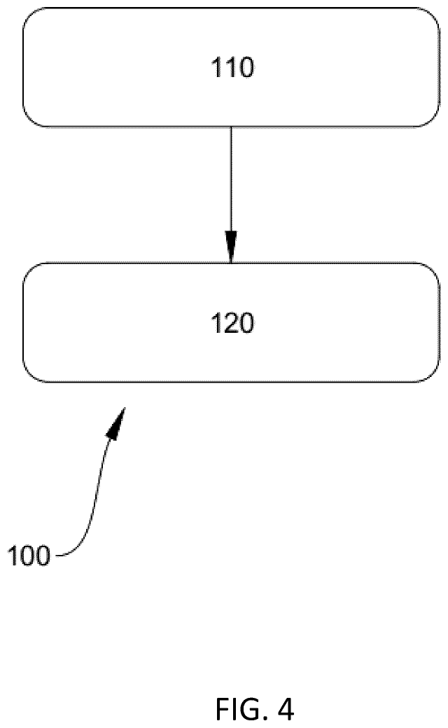

FIGS. 4 and 5 show representations of implemented methods according to the disclosure. One method 100 provides receiving a wireless transmission from the device of the disclosure 110, and outputting the locked or unlocked status of a deadbolt based upon information in the wireless transmission 120. Another method 200 provides fitting a device of the disclosure over or adjacent to a deadbolt lock turnpiece 210, turning the deadbolt lock turnpiece to lock or unlock a deadbolt operably linked to the deadbolt lock turnpiece 220, and generating a wireless transmission from the wireless transmitter 230. Method 200 can further include method 100 after the wireless transmission is generated.

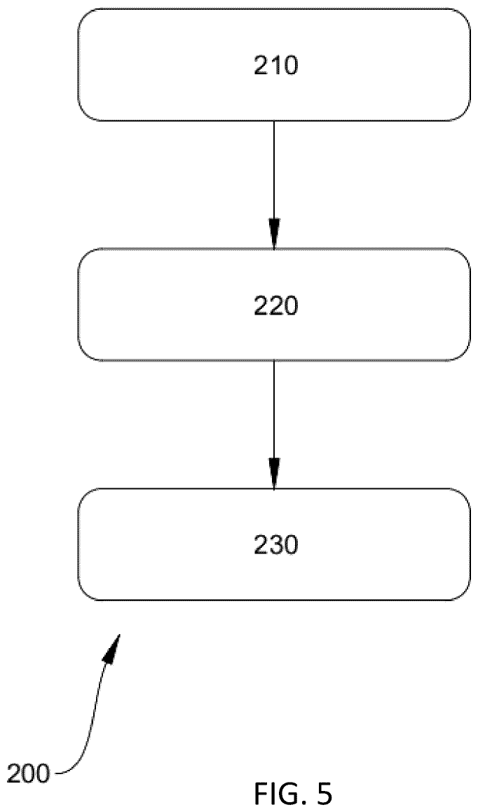

Another implementation of a flexible turnpiece cover 300 is shown in FIGS. 6A-6C. The flexible turnpiece cover can be made of an elastic material which can include one or more flexible polymers previously described. The flexible turnpiece cover 300 has a stretch-over design to work in tandem with an applied sensor 305 on the deadbolt base as shown in FIG. 6A. The flexible turnpiece cover 300 has stretch-over cores 310 for fitting over either end of the turnpiece, as shown in FIGS. 6B and 6C. The cover 300 also includes a battery 315, a main PCB 320 in operable connection to the battery, the main PCB having a Bluetooth BLE 5.0 LE chip in operable connection therewith. The flexible cover also has a USB-C port 325 for providing input to or output from the main PCB 320. Completing the assembly is a light pipe 330 connected to the main PCB which provides an indicator of functioning.

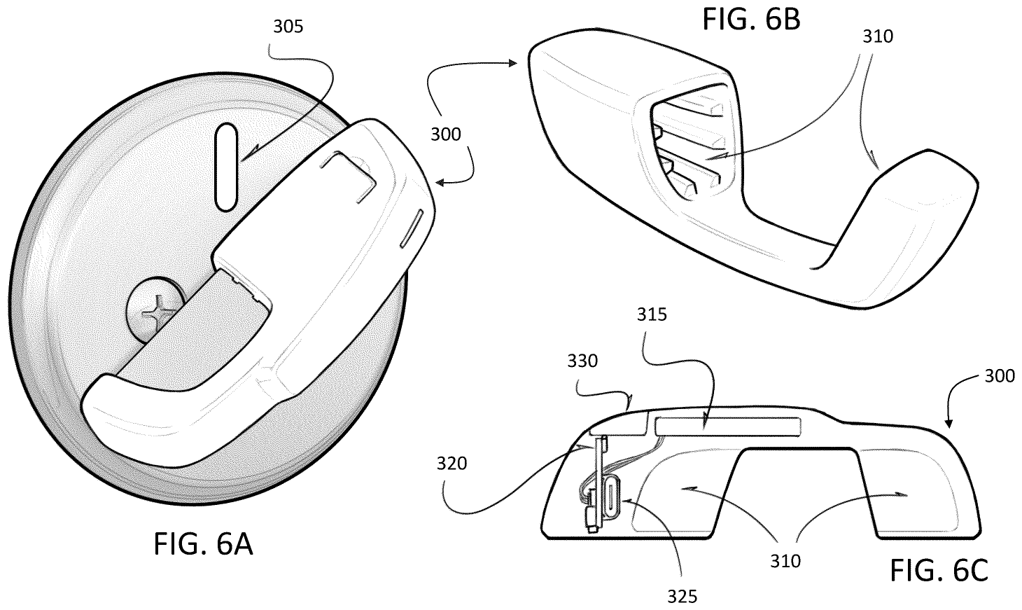

Another implementation, depicted in FIGS. 7A-7B, provides a rigid plastic turnpiece cover where two complementary components 400A and 400B are designed to cover either end of the turnpiece and snap together and over the turnpiece between the two ends of the turnpiece. The components can be made of polycarbonate or plastic polymer of similar hardness. The hard plastic cover works in conjunction with a sensor component 405 positioned on the deadbolt base which can be a metallic sticker for Hall Effect reading of lock position. The hard plastic cover includes a series of rachet grooves 410 on component 400A for fitment to concealed side cups 415 on component 400B which also features an ultrathin cavity 420 for fitment. A thumb grip 425 on component 400A also facilitates installation. FIG. 7C also shows several features of component 400A including a sub-plastic LED 430, a coin cell door 435 for replacement of the battery, the main PCB with Bluetooth BLE 5.0 LE 440, and downward facing dual Hall effect sensors 445.

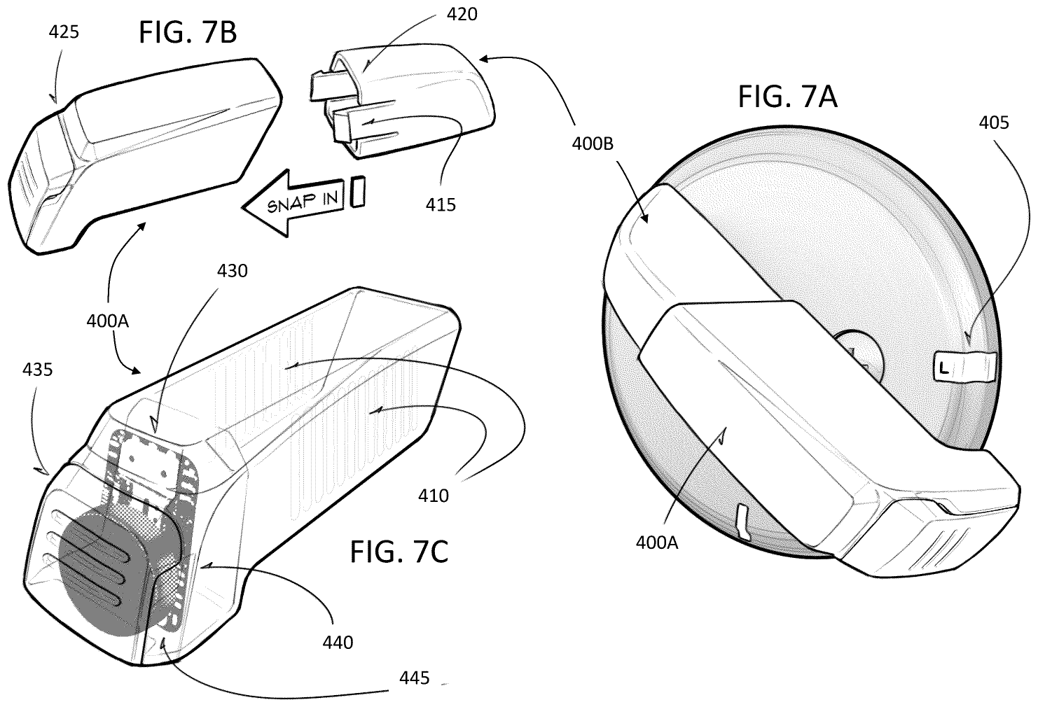

The version depicted in FIGS. 8A-8C features an outer ring 500 which is designed to fit around and surround the deadbolt base. The outer ring 500 can be fitted around the deadbolt base by way of an adhesive. The outer ring implementation 500 includes Hall effect sensors 505 positioned orthogonally to each other, as well as a compartment that includes a battery 510, PCB 515, and LED 520 for flash confirmation that the deadbolt is in a locked position. Not shown are a metallic or magnetic piece of material positioned on and end of the deadbolt turnpiece for detection by Hall effect sensors 505. An alternative implementation includes these components within the plate that is disposed under the deadbolt flashing instead of the outer adhesive ring.

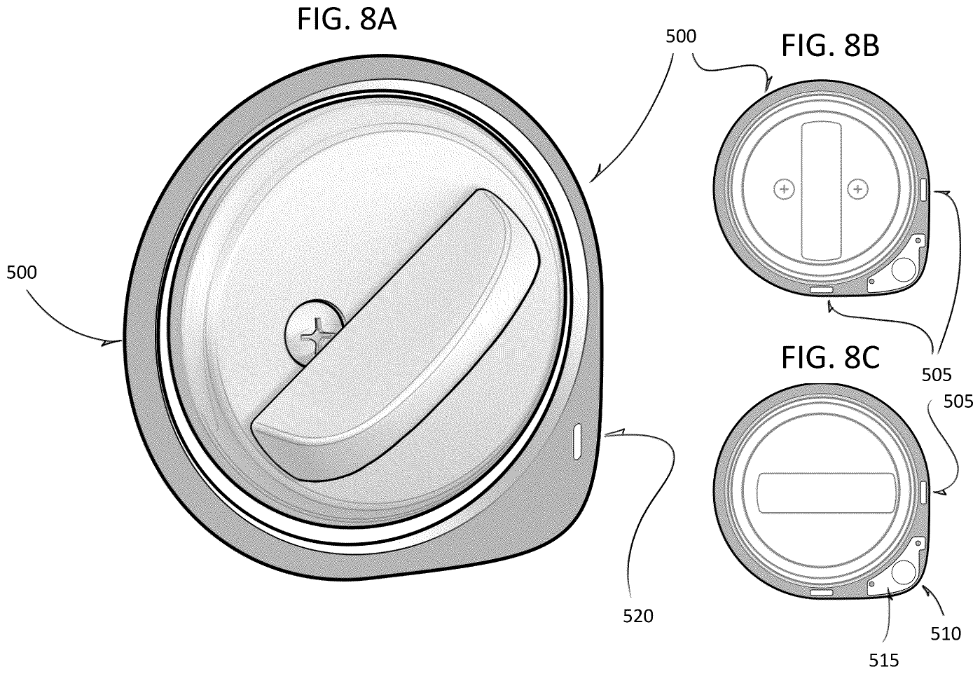

FIGS. 9A-9C depict a two piece embodiment which includes an opaque rigid plastic component 600A and a translucent stretchable component 600B designed to stretch over and lock onto the deadbolt handle or turnpiece. The two components 600A and 600B cover either end of the deadbolt turnpiece and fit together at a midportion of the turnpiece. The hard plastic body 600A includes a fitment compartment 605 for receiving an end of the translucent component 600B, as well as a battery 610 and PCB 615 with Bluetooth chip. An LED indicator 620 is positioned at the end of the opaque component.

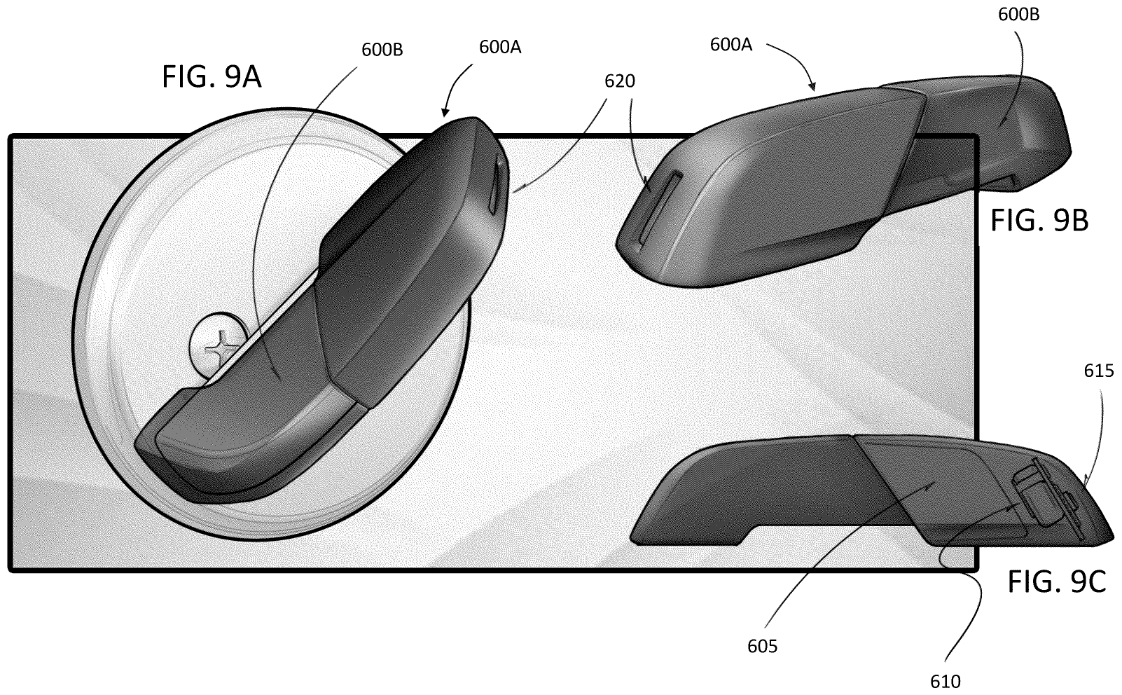

FIGS. 10A and 10B depict a variation of a two component implementation which includes a main body 700A and an access panel 700B that can be customizable in designs and colors chosen by the customer. For example, the access panel cover 700B can be designed to match the color and grain of the door the deadbolt is installed on. The main body 700A includes a battery pocket 705 and PCB pocket 725, as well as an installation notch 715 to allow for installation onto the deadbolt hardware. The two components are designed to snap together along a frontal plane traversing the length of the turnpiece by way of opposing lock tabs 710 on the access panel 700B that mate with a recess 720 on the main body 700A that includes concealed magnetic release pins.

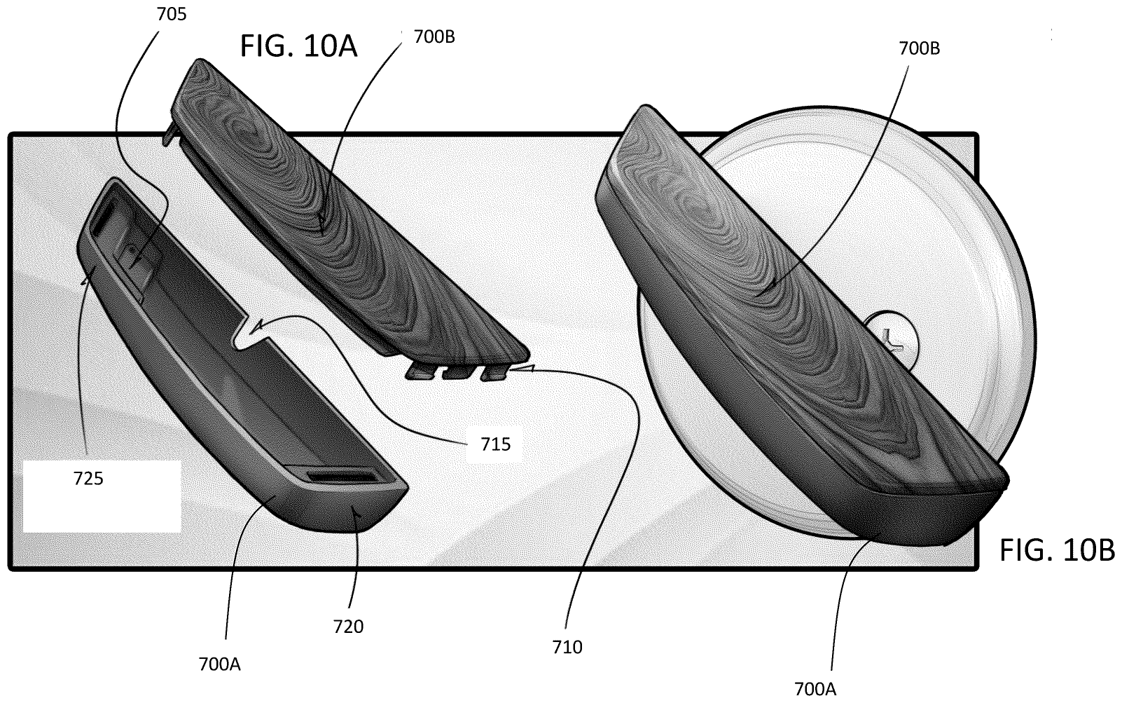

FIG. 11 shows a variation that operates entirely outside the deadbolt mechanism. The variation is implemented as a large battery hosting module 800 or side block attached to the door adjacent to the deadbolt mechanism by way of an adhesive mount 805. The module 800 includes a customizable sensing end 810 that detects the position of the deadbolt handle. This configuration makes the primary node flexible in that it is able to be used with deadbolt assemblies of different shapes and in different orientations. The module is capable of extended use due to the large battery or batteries, such as multiple AAA batteries or a 9-volt battery. A subtle LED indicator is called out at 815. Not shown is a magnet or other metallic indicator positioned on the end of the deadbolt turnpiece that can be sensed by the sensing end 810, such as a magnetometer.

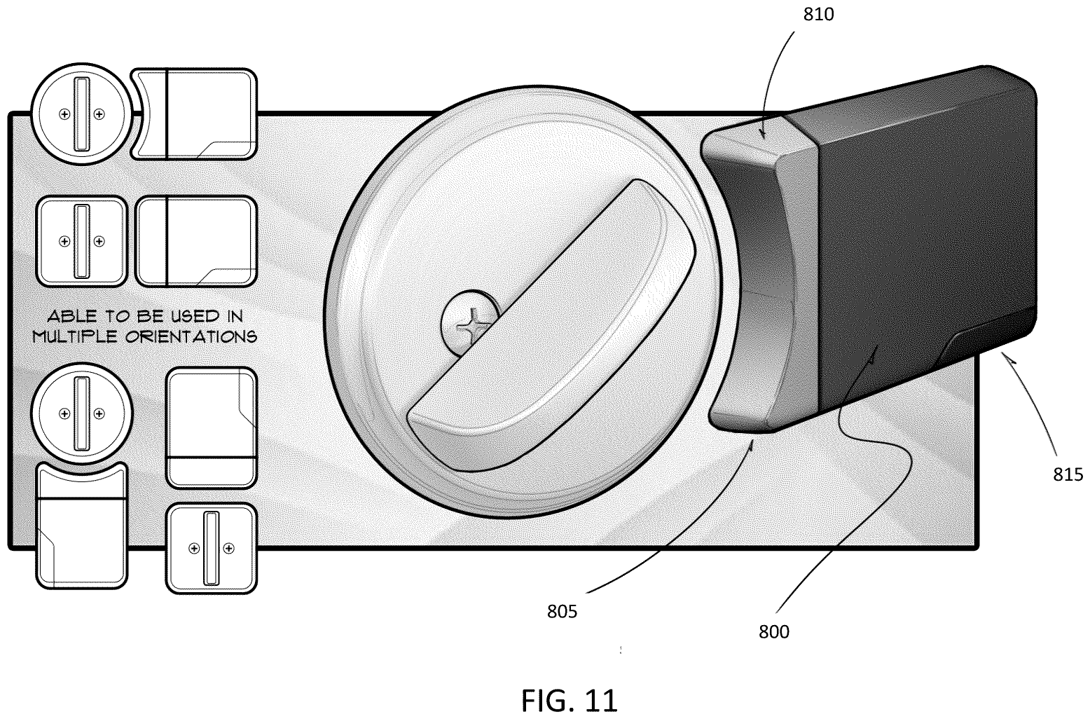

FIGS. 12A-12C show a two-piece assembly 900 capable of quick installation. The assembly includes a flexible arm or body 910 that snaps around the center shaft of the deadbolt piece for easy installation. The flexible arm 910 has a central opening with undulating margins for fitting around and capping one end of the turnpiece. A battery door 905 which doubles as an LED lens for confirmation completes the assembly. The compartment for the PCB and other electronics is shown at 915.

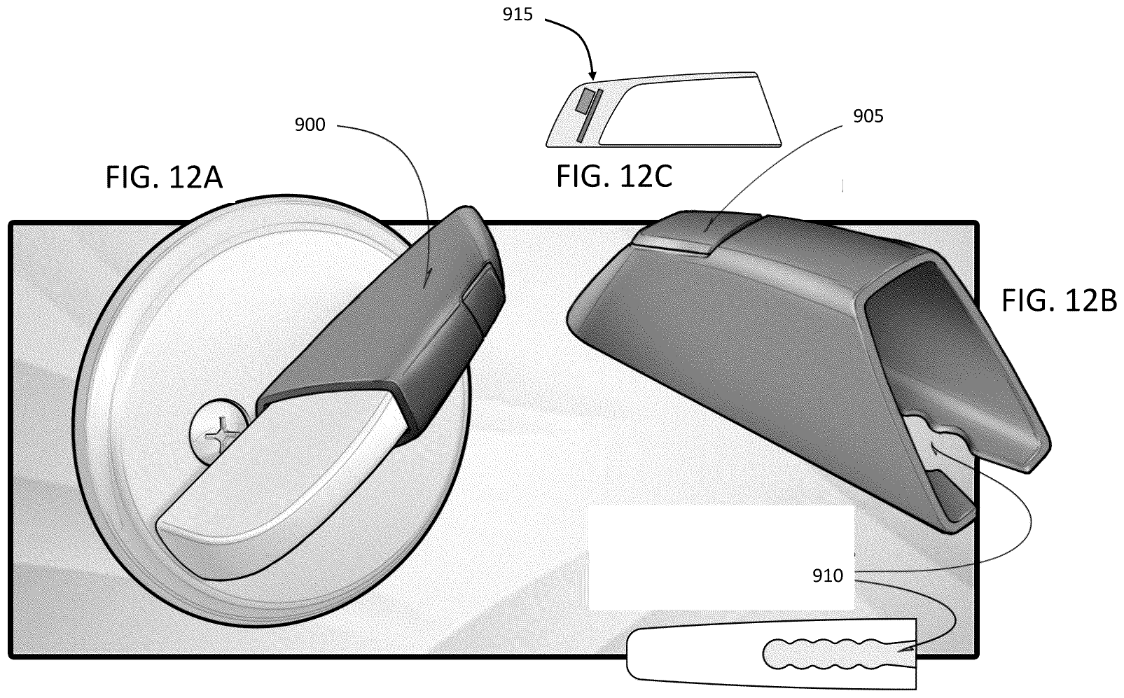

FIGS. 13A-13D feature a 3-zone collapsing structure designed to stretch around most any handle. The module includes a large center cavity 1010 capable of stretching 50% of its length and width to cover 90% of handle modules as well as smaller size flex zones 1015 each having a smaller cavity which flank the center cavity 1010 for tapered handle designs. A compartment 1025 located on a side opposing the cavities provides space for a battery, PCB, and other electronic components.

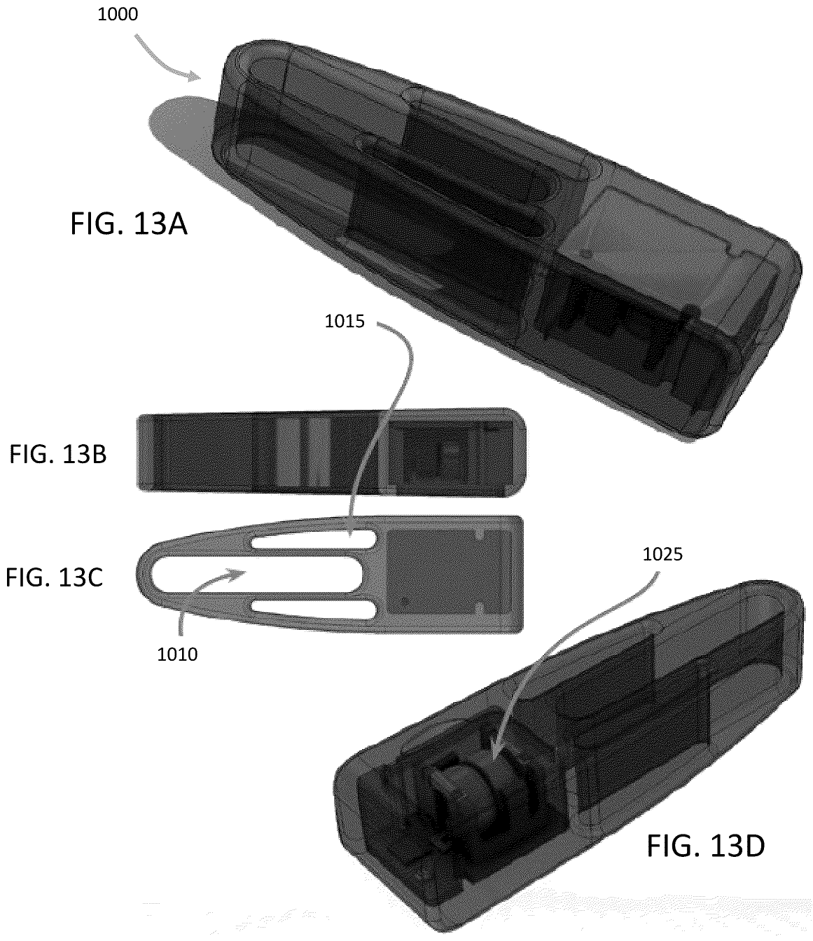

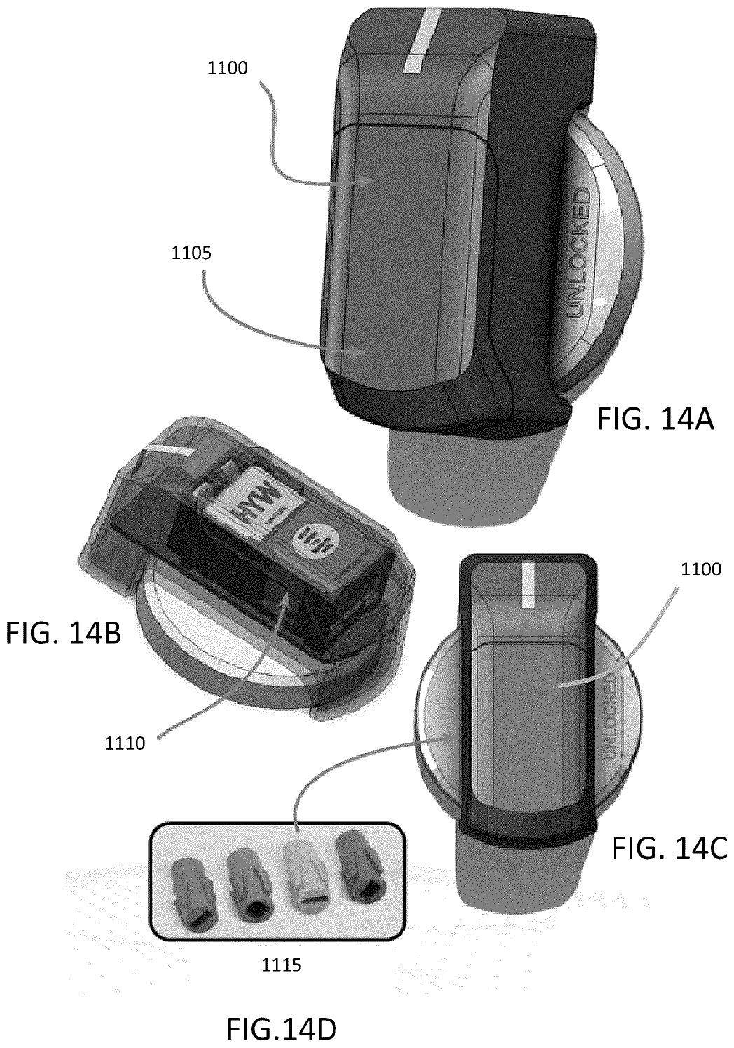

A handle replacement module 1100 that fits over the deadbolt base like a deadbolt handle is shown in FIGS. 14A-14C. The module 1100 includes an easy open outer door 1105 that provides access to the inner compartment 1110 of the module, which includes the battery and electronic components. In this case, the compartment 1110 is capable of holding a 9-volt battery for extended use. Plug inserts 1115 shown in FIG. 14D allow integration of the module 1100 with existing bolt hardware.

Another implementation provides a snap over-front side version that features an extruded profile with press-on end caps. In this version, placement on the deadbolt handle is accomplished by pushing directly on the front center of the handle. The end caps double as lens and battery doors. A battery such as an AAA Battery or Li-Ion pack are disposed on top of the handle.

Another implementation provides an internally hidden device that fits and is concealed behind the faceplate of the deadbolt. This version uses a Hall Effect sensor to more directly detect the position of the lock and is completely concealed with the users of the lock (e.g., tenants) being unaware of its installation. The inner cavity of this version allows for potentially a larger battery storage.

Another version provides straps as a primary means of attachment to the deadbolt handle for providing a non-undercut locking scenario for attachment. The straps are designed to account for a large amount of variability in deadbolt turnpiece design and allow for quick and easy installation.

Another version contemplated involves replacement of the entire turnpiece or handle of the deadbolt. Most handles of deadbolts are based on 1 of 3 shaft types. The replacement handle has the sensors and battery embedded within the housing

Any implementation or version previously described can be implemented with the electronic components and battery pre-installed on or within the device or with one or more components provided separately as a kit to be installed by the user.

In one embodiment, the PCB is a 15 mm×30 mm double-sided board. The PCB is powered by a rechargeable Lithium Ion Polymer (Li-Po) battery with roughly 100 mAh of battery life. The components fit within a compartment dimensioned 2.6×15×34 mm with on-board over circuit protection. The compartment includes a battery holder and space for the PCB, a 5×5 mm Bluetooth or WiFi chip, as well as additional space (of roughly 50 mm²) for additional electronic components.

Devices of the disclosure can be used with existing bolt hardware for a manually operated bolt such that no new bolt hardware is required to be installed. The existing bolt hardware can include a conventional cylindrical casing, cylinder, keyhole, internal pins, thumbturn, and bolt or latch as would be found in most if not all manual deadbolt systems. The existing, conventional bolt hardware lacks electrical contacts, circuitry, a power source, sensors, processors, driveshafts, motors, gears and other components which would be included in an electronic deadbolt locking device. As the devices serve as a standalone system for indicating the locked or unlocked status of a deadbolt, the complexity, cost, and educational training required for installation are dramatically reduced in comparison to electronic deadbolt locking devices; the flexible deadbolt turnpiece cover device can be installed by any consumer.

As can be appreciated by those in the computer engineering arts, inputting steps can be performed through one or more input-output (I/O) interface on a fixed position computer or computers such as a desktop computer or server or on a portable computer/computing device or devices, such as a personal electronic device including a tablet, laptop, PDA, gaming device, or smartphone. Visual prompting can take the form of a message and/or input field provided to the user on a display. The input field can be provided as part of a graphical user interface provided on the display of a computer(s) or computing device(s) which provides one or more data entry fields, check boxes, buttons, toggles, sliders, or pull-downs which allow the user to input information such as a name designation of each deadbolt for each installed deadbolt turnpiece cover device. Auditory prompting can take the form of speech or a recording broadcast from a speaker which prompts the user to enter the information. Inputting steps can be performed through traditional inputting means such as a physical keyboard or a keyboard projected on a display, such as a touchscreen, or through a mouse or trackpad. The keyboard can be a QWERTY keyboard or a condensed keyboard commonly used in electronic devices such as cell phones. Inputting can also be performed through the user providing speech which is inputted through a microphone of the computer(s) or computing device(s) and recognized by speech recognition algorithms programmed on the computer or computing device. Outputting steps can be formed through a visual output device such as a display on the computer(s) or computing device(s) or auditory output device such as a speaker of the computer(s) or computing device(s). The outputting step can display text, symbols, and/or sound indicating the locked or unlocked status of a deadbolt and the door in which it is installed.

Computer-executable code or instructions for performing method steps described or depicted herein or portions thereof can be implemented as software or an application capable of being run on the computer(s) or computing device(s). The computer-executable code or instructions can be installed on the computer(s) or computing device(s) during manufacture as software, or implemented as firmware or hardware (e.g., circuitry), or some combination of these. The computer-executable code or instructions can be configured to be downloadable onto the memory of the computer(s) or computing device(s) from a cloud storage source available on the Internet, such as an application retail source (e.g., “app store”) capable of being accessed from a mobile phone, tablet, laptop, gaming device, desktop computer, or other programmable device having components or features capable of performing the method steps described above. Examples of suitable internet-accessible sources include the Apple Store, Google Play, and other sites that make software applications and other downloads available for purchase or license. In addition to installation on the user's computer(s) or computing device(s), the computer-executable code or instructions can also be hosted on a server or servers accessible to users through a network connection, or can be distributed between a server and an application installed on a user's computer(s) or device(s).

The computer-readable code, computer-readable instructions, computer-executable instructions, or “software” can be organized into routines, subroutines, procedures, objects, methods, functions, or any other organization of computer-executable instructions that is known or becomes known to a skilled artisan in light of this disclosure, and can be programmed in any suitable programming language, including PHP, HTML, XML, XHTML, JavaScript, C, C#, C++, Java, Python, Perl, Ruby, Swift, Visual Basic, and Objective C. By such programming, the computer-readable code, computer-readable instructions, computer-executable instructions, “application” or “software” instruct one or more processors of the computer(s) or computing device(s) to carry out the operations and commands of the application. Inputted information related to the assigned identity of each door where each deadbolt turnpiece cover is installed can be stored in the computer(s) or computing device(s)'s memory with the computer executable instructions. The memory can be implemented through non-transitory computer-readable storage media such as RAM. As used in the context of this specification, a “non-transitory computer-readable storage medium (or media)” may include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM.

In one implementation, a computer system for performing the method steps includes 1) one or more computer that is located remotely from a user and connected to the Internet and to each other and 2) a computer or computing device accessible to the user that can communicate with the remote computer(s) through a network. The remote computer(s) can be a fixed position computer, and the user's computer or computing device can be fixed such as a desktop computer or mobile/portable. The user's computer or device can be a desktop computer, laptop, tablet, gaming device, PDA, or smartphone that can access or display the graphical user interface depicted in FIG. 3. The graphical user interface can be downloaded as part of an application from cloud storage services providing retail application downloading to the user's computer or computing device, or can be hosted on a remote computer which acts as a web server and accessed through the internet as webpages through an Internet browser on the user's computer or computing device. The methods need not be limited to one particular distribution of functions on a single computer or multiple computers; multiple configurations hosted on one or more computers are contemplated. In one implementation, the graphical user interface 50 shown in FIG. 3 is accessible through a webpage, and the information with respect to the locked and unlocked status of a door deadbolt is stored in a cloud relational database such as those provided by Oracle and/or hosted by Amazon Web Services. The application on the user's computer or computing device provides updates on the deadbolt status information continuously or at predetermined times. In this way, the user has a historical record of whether a door deadbolt has been locked or unlocked.

Additional embodiments include a computer, computing device, or system or combination thereof capable of carrying out the method and its implementations or portions thereof. The computer, computing device, system or combination thereof can include one or more processors capable of executing the computer-readable code, computer-readable instructions, computer-executable instructions, or “software”, one or more interface capable of providing input or output, one or more memories and a set of instructions (e.g., software) stored in a memory or memories of the computer, computing device, or system or combination thereof for carrying out the method. The computer, computing device, or system or combination thereof can include one or more stand-alone computer, such as a desktop computer, a portable computer or personal electronic device, such as a tablet, laptop, PDA, gaming device, or smartphone, or a set of computers or devices connected through a network including a client-server configuration and one or more database servers. The network can use any suitable network protocol, including IP, UDP, or ICMP, and may be any suitable wired or wireless network including any local area network, wide area network, Internet network, telecommunications network, Wi-Fi enabled network, or BLUETOOTH® enabled network. Other protocols include Hypertext Transfer Protocol (HTTP), extensible markup language (XML), extensible hypertext markup language (XHTML), or a Wireless Application Protocol (WAP) protocol. In this way, one or more steps of the methods can be distributed across the system or combination, or performed on only one computer or computing device, according to specific applications or designs.

Computers, computing devices, or systems thereof described herein can include a variety of components known in the art, including one or more processor, a volatile memory, a non-volatile memory, standard I/O interfaces such as a universal serial bus (USB) port, an HDMI or HDMI ARC port, an optical port, an ethernet port, and/or a serial port, a hard drive, a disk drive, a CD-ROM drive, a motherboard, a printed circuit board (PCB), circuitry for enabling a wireless connection or communication to another device, such as a BLUETOOTH® board, a Wi-Fi board, or a transmitter-receiver for mobile telecommunications, a data bus, an address bus, a control bus, and/or one or more user interface devices including a display, keyboard, keypad, trackpad, mouse, control panel, touch screen display, speaker, camera, and/or microphone. The computers, computing devices, or systems thereof can be equipped with an operating system implemented as software or firmware. As can be appreciated, the computers, computing devices, or systems may differ in their inclusion, exclusion, or configuration of components according to their individual applications or designs.

Another implementation provides a system including a device of the disclosure and a computer, computing device, or system thereof. The device of the system senses whether a door is locked or unlocked and transmits that information to the computer or computing device of the system, by way of the sensor and transmitter previously described. The computer or computing device of the system receives the information and displays the information on a graphical user interface. The system or device thereof can be used as follows. A user installs the device on a deadbolt turnpiece. The user then manually locks or unlocks the deadbolt of the door with the deadbolt turnpiece. The device detects whether the door deadbolt is locked or unlocked and transmits the information to the computer or computing device by way of a BLUETOOTH® connection between the device and the computer or computing device. The user accesses an application installed on the computer or computing device and then reads or sees the locked or unlocked status of the deadbolt on a graphical user interface of the application. This can be repeated with multiple installations of the device for different doors.

The present disclosure has described particular implementations having various features. In light of the disclosure provided above, it will be apparent to those skilled in the art that various modifications and variations can be made without departing from the scope or spirit of the disclosure. One skilled in the art will recognize that the disclosed features may be used singularly, in any combination, or omitted based on the requirements and specifications of a given application or design. When an implementation refers to “comprising” certain features, it is to be understood that the implementations can alternatively “consist of” or “consist essentially of” any one or more of the features. Other implementations will be apparent to those skilled in the art from consideration of the specification and practice of the disclosure.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the disclosure fall within the scope of the disclosure. Further, all of the references cited in this disclosure including patents, published applications, and non-patent literature are each individually incorporated by reference herein in their entireties and as such are intended to provide an efficient way of supplementing the enabling disclosure as well as provide background detailing the level of ordinary skill in the art.

1. A device, comprising:
flexible material designed to fit over a deadbolt lock turnpiece of a portion thereof;
a sensor designed to detect whether the deadbolt lock turnpiece is in a horizontal or vertical position; and
a wireless transmitter operatively connected to receive output from the sensor.

2. The device of claim 1, wherein the flexible material forms at least one core designed to fit over an end of the deadbolt lock turnpiece.

3. The device of claim 2, wherein the flexible material forms two opposed cores designed to fit over either end of the deadbolt lock turnpiece with a stretchable component therebetween.

4. The device of claim 1, comprising a rigid end designed to fit over one end of the deadbolt lock turnpiece and an opposing flexible end comprising the flexible material and designed to fit over an opposing end of the deadbolt turnpiece.

5. The device of claim 1, comprising a center cavity capable of stretching around a deadbolt lock turnpiece.

6. The device of claim 5, further comprising a pair of flexible zones flanking the center cavity each having a smaller cavity.

7. The device of claim 1, wherein the sensor is disposed on a deadbolt base.

8. The device of claim 1, wherein the sensor is disposed on or underneath the flexible material.

9. The device of claim 1, wherein the sensor is a magnetometer.

10. The device of claim 1, further comprising a LED.

11. A device, comprising:
rigid material designed to fit over a deadbolt lock turnpiece or a portion thereof;
a sensor designed to detect whether the deadbolt lock turnpiece is in a horizontal or vertical position; and
a wireless transmitter operatively connected to receive output from the sensor.

12. The device of claim 11, wherein the rigid material comprises a pair of complementary rigid pieces designed to snap together.

13. The device of claim 12, wherein the pair of complementary rigid pieces are designed to cover opposing ends of the deadbolt lock turnpiece and snap together therebetween.

14. The device of claim 13, wherein the pair of complementary rigid pieces are designed to snap together by way of ratchet grooves one a first piece and side cups on a second piece.

15. The device of claim 12, wherein the pair of complementary rigid pieces are designed to snap together along a frontal plane transversing a length of the device.

16. The device of claim 15, wherein the pair of complementary rigid pieces comprises a main body and an access panel designed to cover a chamber in the main body.

17. The device of claim 15, wherein the pair of complementary rigid pieces comprises a first rigid piece comprising lock tabs and a second rigid piece comprising a recess designed to receive the lock tabs.

18. The device of claim 15, wherein at least one piece has a notch designed to be installed over deadbolt hardware.

19. The device of claim 11, wherein the sensor is disposed on a deadbolt base.

20. The device of claim 11, wherein the sensor is disposed on or underneath the rigid material.

21. The device of claim 11, wherein the sensor is a magnetometer.

22. The device of claim 11, further comprising a LED.

23. A device comprising:
a module designed to replace a deadbolt lock turnpiece and integrate with deadbolt hardware;
a sensor designed to detect whether the deadbolt lock is in a locked or unlocked position; and
a wireless transmitter operatively connected to receive output from the sensor. wherein the module has a compartment designed to fit a battery, a PCB, and the wireless transmitter;
wherein the module integrates with deadbolt hardware by way of plug inserts that join the module with the deadbolt hardware.

24. The device of claim 23, wherein the compartment is designed to fit a 9-volt battery.

25. The device of claim 23, wherein the sensor is disposed on a deadbolt base.

26. The device of claim 23, wherein the sensor is disposed on or within the module.

27. The device of claim 23, wherein the sensor is a magnetometer.

28. The device of claim 23, further comprising a LED.
